(19) United States
(12) Patent Application Publication
(10) Pub. No.: US 2009/0287548 A1
(43) Pub. Date: Nov. 19, 2009

(54) METHOD AND SYSTEM FOR TRANSFORMING INFORMAL UNTRADEABLE PROPERTY TO FORMAL TRADEABLE PROPERTY

(76) Inventor: Elena Panaritis, Washington, DC (US)

Correspondence Address: BACON & THOMAS, PLLC, 625 SLATERS LANE, FOURTH FLOOR, ALEXANDRIA, VA, 22314-1176, US

(21) Appl. No.: 12/466,367

(22) Filed: May 14, 2009

Related U.S. Application Data
(60) Provisional application No. 61/071,719, filed on May 14, 2008.

(51) Int. Cl. G06Q 40/00; G06Q 10/00; G06Q 50/00

(52) U.S. Cl. 705/10; 705/7; 705/35

(57) ABSTRACT

A method and system for transforming informal, untradeable properties into formal, tradeable properties in is carried out by controlling the design and implementation of regulatory and/or legal changes and by aligning interests of investors and governments to those changes.

This application claims the benefit of U.S. Provisional Patent Application Ser. No. 61/071,719, filed May 14, 2008.

### BACKGROUND OF THE INVENTION

1. Field of the Invention

This invention generally relates to a method and system for transforming informal, untradeable property (which may also be referred-to as “unreal” estate) into formal, tradeable property. The method involves controlling the design and implementation of a new property rights system based on necessary regulatory and/or legal changes and by aligning interests of investors, governments, and others to those changes, in order to secure property assets' social, environmental, and economic positive attributes, one of which is to adjust upwards the value of the property to full market value.

The invention provides improvements and/or practical implementation techniques relative to the method described in the publication Prosperity Unbound: Building Property Markets with Trust by Elena Panaritis, Palgrave Macmillan, 2007, which is incorporated herein by reference.

2. Description of Related Art

The phrase “transformation of informal untradeable property into formal tradeable property” as used herein refers to a process by which land or real property assets in markets that have been distorted by over-regulation, poor regulation, complicated legal and administrative procedures, inadequate property rights definition and enforcement, lack of standardized market information and knowledge, and so forth are converted into assets that can be traded or sold securely with managed risk and at full market value. Examples of communities with undervalued or distorted real estate property markets are found not only in many developing countries, but also in economically disadvantaged urban and rural areas of developed countries such as the United States. Such communities are usually called distressed communities and are characterized in that the population of these communities suffer from a severe wealth distortion that adds to the commonly known income distortion.

The invention applies to any real property market where ownership, registration, or title to property is unclear and property rights are not fully protected, resulting in social, economic, and environmental positive impacts, including but not limited to:

### Social Negative Impacts

higher propensity of child labor;
weakening and thinning of middle class;
very low women's participation in community, their families, individual wealth, and politics;
marginalization of poor communities;
marginalization of minorities;
main occupation is done by cottage industries;
very low levels of security among owners, the government, and private investors or bankers;
low level of proper governance of property and civil service;
low sense of civil engagement and individual responsibility to the community and the State;
high concentration of crime and delinquency;

### Economic Negative Impacts

concentration of poor and low income people;
low levels of liquidity;
thin primary and secondary investments with property being the asset backing the investments;
sources of financing limited to individual's local savings—and when it exists friends and family;
properties become difficult to value and price correctly—the price mechanism is distorted and broken;
speculation trends become prominent that can lead property markets to become precarious;
capital markets become weak and vulnerable to crisis;
labor mobility becomes larger and safer;
cheaper access to private credit;
higher volume of private investment;
stronger and robust mortgage markets with less vulnerability to risk and crisis;
harmonized property prices;
better and more efficient use of economic resources;

### Environmental Negative Impacts

salination of agricultural lands;
difficult to design, apply and enforce urban zoning and planning;
easier to destruct forestation;
ineffective management of urban sprawling;
high level of waste in energy resources and water resources;
higher levels of carbon footprint;
ineffective waste management.
   According to the World Bank, the United Nations, the United Nations Development Program “Commission for the Empowerment of the Poor” and other academics, such undervalued property assets may represent on the order of 70% of the world's property assets, affecting more than four billion people around the world and more than nine trillion U.S. dollars. The undervalued assets can be either publicly or privately owned, or a combination thereof. In either case, the invention seeks to align the interests of investors, governments, and citizens to necessary regulatory and/or legal changes that, once made, provide positive social and environmental impact together with market competitive financial returns, among which are high returns to investors and a wider tax base, and increased political stability for governments.

### SUMMARY OF THE INVENTION

It is accordingly an objective of the invention to provide a method and system for transforming informal, untradeable properties that are undervalued due to regulatory and/or legal impediments into formal, tradeable properties, thereby achieving positive social, environmental, and economic impacts such as adjusting the values of the untradeable properties to full market value.

This objective is achieved, in accordance with the principles of a preferred embodiment of the invention, by providing a method, and a system for implementing the method, that includes the steps of: (a) identifying property potentially subject to transformation according to the principles of the invention; (b)identifying partners that will participate in the process of the invention; (c) engaging the partners; (d) securing contracts with government and/or land owners; (e) diagnosing reasons why the property is informal or “unreal” and therefore subject to transformation according to the principles of the invention, and deciding to proceed with the method only if the reasons concern institutional/regulatory mismatches that are subject to reform; (f) applying the methodology described in Panaritis, Prosperity Unbound: Building Property Markets with Trust, cited above, to identify and collect data necessary to define properties in a way that permits transformation into formal, tradeable properties, including identification of parties, collection of data on legal, regulatory, usage, and/or any other issues that may affect implementation of the process, collection and clearance of property rights information, verification of property borders, as well as legal and fiscal aspects of individual properties, and registration of the properties; (g) designing new rules to carry out the transformation to tradeable properties; (h) calibration of the rules and collection of legal contingencies to correct the design over time; and (i) design and/or customization of software to contain geographic and legal information collected in steps f and h. In addition, the methodology preferably includes the step (j) of developing of certification procedures for training instructors in order to perpetuate the system of formal or tradeable property rights established in steps a to h.

### DESCRIPTION OF PREFERRED EMBODIMENTS

The following is a more detailed description of the methodology summarized above. Specific procedures used to carry out the steps described below, may be found in Panaritis, Prosperity Unbound: Building Property Markets with Trust, cited above. The methodology provides a practical framework for implementing the economic principles set forth in the Panaritis publication.

As noted above, the methodology of the invention is used to transform informal, untradeable properties that are undervalued due to regulatory and/or legal impediments into formal, tradeable properties. However, it will be appreciated there may be reasons why properties are untradeable or undervalued other than those described above. For example, the problem may simply be one of organizational lag, in which case the methodology of the invention would not be necessary and the steps to follow would not be carried out.

If implementation of the invention according to the principles described in the above-cited Panaritis publication is called for, then the first step is to identify specific properties potentially subject to the process of transformation from informal or unreal property to formal tradeable property. These properties will typically have one or more of the following characteristics: overly complicated regulator regimes related to the ownership, usage, zoning, or planning, pending expropriation claims, concessions, and/or overruled regulations that are still formally in existence, although these characteristics should not be taken as exclusive.

The next step, following identification of countries or distressed communities with property markets to which the process of the invention may be applied, is to identify entities that are required to participate in the process of deregulation and alignment of government and investor interests. This involves identification of (i) responsible parties in state and local government; (ii) entities with interests in the property to be transformed, including private and/or public property owners; and (iii) facilitators, i.e., those with know-how and private investment money for implementing the method. As the methodology of the invention is carried out, this information will be used in order to assign the appropriate professionals and reform leaders who will become “partners” and help with the overall implementation of the invention.

Once the potential partners and properties have been identified, then the partners must be contacted and participation solicited. Participation will, in many cases, likely be contingent on the next and very critical step in the methodology, which is securing contracts with government and any private entities with interests in the countries, distressed communities, and/or property markets to be transformed, and establishing collaborating agreements with private investors.

At some point during the steps of contacting parties and securing agreements, an analysis must be undertaken to diagnose the reasons why the identified property is undervalued. This depends, primarily, on whether the transformation sought by the invention can be achieved by institutional reform.

If conditions are suitable for proceeding with the preferred methodology, then the next step is to apply and/or implement the principles described in the Panaritis publication for the purpose of collecting and clearing property rights and providing for their future enforcement, by collecting and cataloging the information necessary to define property rights in such a way as to determine how to deregulate the properties and enable correct valuation and trading or arbitrage, i.e., accomplish the actual transformation into formal, tradeable properties. This involves the steps of establishing agreements/relationships with authorities in identified governmental entities; manufacture of data collection process and creation of registration cells listing legal issues, regulatory issues, paper clarification issues, and conflict issues. The “paper clarification issues” include clarification of property usage, boundaries, and so forth, while “conflict issues” include issues of conflicting property usage/rights as they appear in a formal property rights system, such as trespassing, border conflicts, eminent domain claims, claims from utility companies, old infrastructure projects, old public or private claims and conflicts involving conflicting usage applications on the same property plot, or even adverse possession issues. In addition, information held by governmental and non-governmental authorities, including municipalities, mapping agencies, military cartographers, judicial registries, property registries, civil registries, etc., must be collected, and overlapping legal, jurisdictional, and economic claims as well as existing urban and/or rural development identified, and the data clarified. Finally, it is also necessary to clarify general borders listed in city and state master plans, including neighborhood and property borders, to identify the number of owners, and to catalog this information so that property borders and legal and fiscal aspects of individual properties can be verified and each property in the system registered.

The final steps of the methodology of the invention are to design rules for transforming informal, untradeable properties into formal, tradeable properties, based on principles described in Prosperity Unbound: Building Property Markets with Trust by Elena Panaritis, incorporated herein by reference; calibrate the new rules and regulations based on feedback from property owners and continuously collect legal contingencies to fit in and correct the new rules and regulations as necessary over time; and design and/or customize computer software that includes one or more databases stored on an information storage medium containing both geographic and legal information collected in the steps described above. Optionally, to ensure that the system established by the methodology of the invention can be maintained, it may be desirable to establish certification procedures for system administration instructors/trainers.

In order to provide incentives for carrying out steps a-j and attract investors, it is in practice necessary when establishing collaborating agreements with the government (step d), to obtain rights of exclusivity to deregulate the jurisdictions in place and to apply a regulatory arbitrage (trading) based on the methodology of the invention. The return for the investors is anticipated to result from rights to land equity, which is shared with the owners of the properties, whether private or public, and therefore equity rights must be secured and guaranteed by the government no later than step d.

The catalogs and registration information developed while carrying out the methodology of the invention is preferably included in the geographic information for the software designed or customized after the information has been collected, which together with the collected legal contingencies, and within the legal framework of the country, defines the subject properties in a way that allows them to be valued and traded. Development and maintenance of such “packages” of information are the end result of carrying out the method of the invention.

Even though the invention involves a specific procedure for transforming informal, untradeable properties into formal, tradeable properties, it will be appreciated that conditions vary widely between property markets around the United States and the world, and that variations of the above procedure may be made without departing from the scope of the invention.

I claim:

1. A method of transforming informal, untradeable properties into formal, tradeable properties, said properties including interests in land or real property, comprising the steps of:
a. identifying countries, distressed communities, and/or property markets subject to said transformation of informal, untradeable properties into formal tradeable properties;
b. identifying entities that are required to participate in the process of deregulation and alignment of government and investor interests;
c. securing the engagement of identified entities;
d. securing a contract with government and with any private entities with interests in the property to be transformed and, in parallel, establishing collaborating agreements with private investor(s);
e. diagnosis of reasons why property is undervalued; if not, terminating the method;
f. collecting and cataloging information in order to define properties in such a way as to enable trading;
g. designing rules for transforming informal, untradeable properties into formal, tradeable properties;
h. calibrating the new rules and regulations based on feedback from property owners and continuously collecting legal contingencies to fit in and correct the new rules and regulations as necessary over time; and
i. designing and/or customizing software containing both geographic and legal information collected in step h.

2. A method as claimed in claim 1, wherein the entities identified in step a are selected from (i) state and local government; (ii) entities with interests in the property to be transformed, including private and/or public property owners; and (iii) facilitators, including those with know-how and private investment money for implementing the method

3. A method as claimed in claim 1, wherein the properties identified in step b have one or more the following characteristics: overly complicated regulator regimes related to the ownership, usage, zoning, or planning, pending expropriation claims, and/or overruled regulations that are still alive.

4. A method as claimed in claim 1, wherein step e comprises the step of determining whether said transformation can be achieved by institutional reform.

5. A method as claimed in claim 1, wherein step f comprises the steps of:
f1. establishing agreements with authorities in identified governmental entities;
f2. manufacturing a data collection process and creating registration cells;
f3. designing, applying, and implementing processes that collect and clear property rights information as well as establish their future enforcement.

6. A method as claimed in claim 5, wherein step f2 comprises the steps of:
(i) listing legal issues;
(ii) listing regulatory issues;
(iii) listing paper clarification issues, including clarification of property usage, boundaries, and so forth;
(iv) listing of any other issues that may affect the transformation.

7. A method as claimed in claim 5, wherein step f3 comprises the steps of:
(i) collecting any information held by governmental and non-governmental authorities, including municipalities, mapping agencies, military cartographers, judicial registries, property registries, civil registries, etc.; identifying overlapping legal, jurisdictional, and economic claims, identifying existing urban and/or rural development, and cataloging the data;
(ii) clarifying general borders listed in city and state master plans, including neighborhood and property borders, identifying the number of owners, and cataloging this information;
(iii) verifying property borders and legal and fiscal aspects of individual properties; and
(iv) registering each property in the system of the invention.

8. A method as claimed in claim 1, further comprising the step of establishing certification procedures for system administration instructors/trainers.

9. A system for enabling transformation of informal, untradeable properties into formal, tradeable properties, comprising software including a database stored on an information storage medium and containing both geographic and legal information, said software being the result of carrying out the steps recited in any of claims 1-8.
